(19) United States
(12) Patent Application Publication
(10) Pub. No.: US 2003/0165287 A1
(43) Pub. Date: Sep. 4, 2003

(54) System and method for distribution of information using wideband wireless networks

(76) Inventors: Jerry A. Krill, Ellicott City, MD (US); William H. Zinger, Columbia, MD (US); Joseph J. Suter, Ellicott City, MD (US)

Correspondence Address: Ernest R. Graf, Office of Patent Counsel, The Johns Hopkins University, Applied Physics Laboratory, 11100 Johns Hopkins Road, Laurel, MD, 20723-6099, US

(21) Appl. No.: 10/374,491

(22) Filed: Feb. 26, 2003

Related U.S. Application Data
(60) Provisional application No. 60/360,478, filed on Feb. 27, 2002.

(51) Int. Cl. G02B 6/26

(52) U.S. Cl. 385/24

(57) ABSTRACT

An information distribution system using wideband wireless networks for the bi-directional distribution of information between a fiber optic cable and at least one location having a distribution network for distributing the information within the location, comprising a junction box connected to a fiber optic cable information system for transceiving a signal of a fiber optic cable and a wideband wireless signal, and a first house node located at a first of the at least one location for transceiving the wideband wireless signal and a signal for use in the distribution network of the at least one location.

### CROSS-REFERENCE TO RELATED APPLICATION

This application claims priority to provisional application No. 60/360,478 entitled “Cable-to-House Wideband Wireless Link and Relay” filed in the United Stated Patent and Trademark Office on Feb. 27, 2002, the contents of which are incorporated herein by reference.

### BACKGROUND OF THE INVENTION

1. Field of the Invention

The present invention relates generally to a system and method for distribution of information, and in particular, to a system and method for distribution of information using wideband wireless networks.

2. Description of the Relation Art

In recent years, cable television providers have expanded their services to include not only traditional television programming, but also digital television services, telephone communications and high-speed Internet access. The digital television services include, for example, on demand programming, information streams associated with individual television programs, station information, and programming guides. The telephone services that were traditionally provided by a local telephone company are now being carried through the cable equipment. The high-speed Internet access is proving to be a windfall for the cable companies. Each of these services alone requires a significant amount of bandwidth of the cable lines and, in total, the amounts of bandwidth demanded from the customers is growing every day. The bi-directional nature of the above services also increases the bandwidth need.

In an effort to increase the bandwidth capabilities of the cable lines, the cable companies are replacing the traditional coaxial cables with fiber optic cables. The upgrade of equipment is costing great amounts of money, the costs of which are in turn passed on to the customer. The cable companies are also incurring great costs in installing the fiber optic lines into areas of new construction, and the repair and replacement costs are high. Although these upgrades increase the bandwidth capacity of the existing systems, due to ever-increasing consumer needs and demands for greater bandwidth, it will not be long before the entire bandwidth of the coaxial cable, phone line or microwave wireless bandwidths will be exhausted and rendered obsolete. Additionally, in mountainous or rocky terrain areas, the laying of fiber optic or coaxial cables to specific locations might be impractical or altogether impossible.

Typically, a cable system consists of an in ground or above ground feeder cable. The feeder cable carries the entire optical cable spectrum that consists of the television services, the telephone services, and the Internet services. The feeder cable runs throughout an entire neighborhood, and each house taps off of the feeder cable to individually connect to the system. Filters are usually located between the feeder cable and each house to enable the cable company to provide specific services to specific houses. Generally at each house there is a converter box that converts the fiber optic signal into an electromagnetic signal to be carried throughout the house on coaxial cables. Each neighborhood system contains miles and miles of fiber optic cables, the costs of which are again passed along to the consumer. Also, as each new customer or each new location is added to the system, more cable is required.

One method of reducing the costs associated with miles of cable is to wirelessly transmit information. Currently, microwaves are a common medium used to transmit such information. Unfortunately, microwave signals are high energy and penetrate a human body. The long wavelength of microwave energy allows the microwave radiation to penetrate the body more than shorter wavelength energies, even at the same power levels. The long-term effects of the microwave effects on the human body are being studied and potentially could costs millions in future liability costs.

There is therefore a need to provide an information distribution system having greater networking and information bandwidth, reduction of obsolescence costs, increases in mobility, lower human electromagnetic exposure, and reduced costs of services.

### SUMMARY OF THE INVENTION

It is, therefore, an aspect of the present invention to provide a system and method for distributing information using wideband wireless networks.

The foregoing aspects of the present invention are realized by a system for the bi-directional distribution of information between a fiber optic cable and at least one subscriber location having a distribution network for distributing the information within the subscriber location, comprising a junction box connected to a fiber optic cable information system for transceiving a signal of a fiber optic cable and a wideband wireless signal, and a first node located at a first of the at least one subscriber location for transceiving the wideband wireless signal and a signal for use in the distribution system of the at least one subscriber location.

In a preferred embodiment of the present invention, a method for the bidirectional distribution of information between a fiber optic cable and at least one subscriber location having a distribution system for distributing the information within the subscriber location, comprises the steps of transceiving by a junction box connected to a fiber optic cable information system a signal of a fiber optic cable and a wideband wireless signal, and transceiving by a first house node located at a first of the at least one subscriber location the wideband wireless signal and a signal for use in the distribution network of the at least one subscriber location.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram of a system for distributing information using wideband wireless networks according to an embodiment of the present invention;

FIG. 2 is a diagram detailing a junction box of FIG. 1; and

FIG. 3 is a diagram detailing a house node of FIG. 1.

### DESCRIPTION OF THE PREFERRED EMBODIMENTS

A preferred embodiment of the present invention will be described herein below with reference to the accompanying drawings. In the following description, well-known functions or constructions are not described in detail since they would obscure the invention in unnecessary detail.

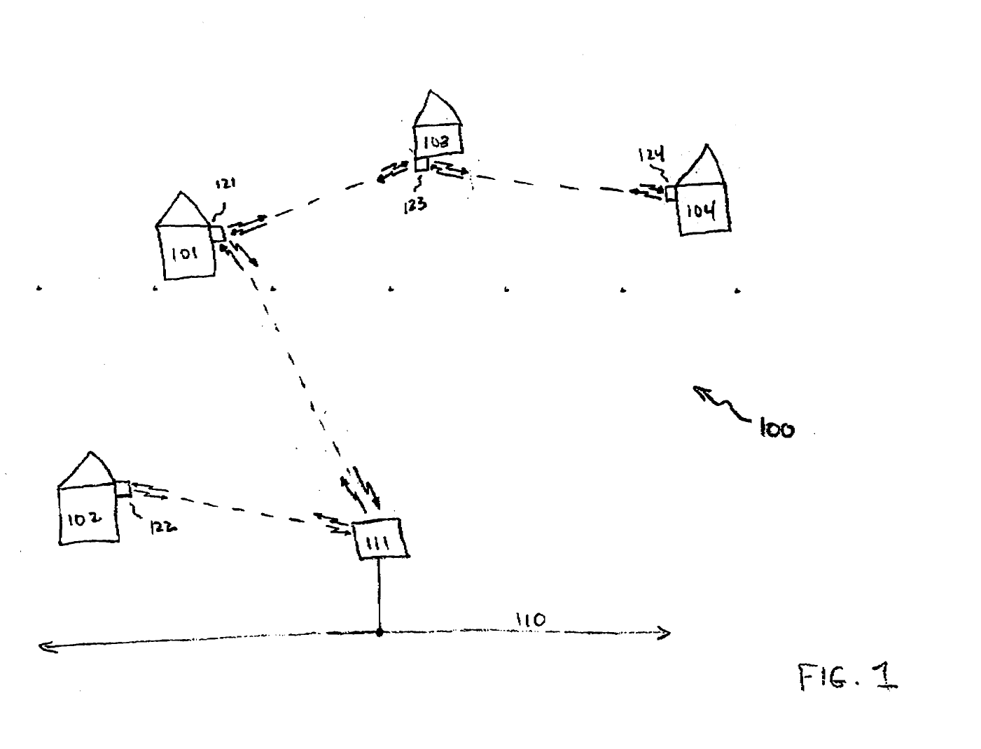

FIG. 1 is a diagram of a system for distributing information using wideband wireless networks according to an embodiment of the present invention. Shown in FIG. 1 is neighborhood 100, containing a plurality of houses (or other buildings) including houses 101-104. Although a plurality of houses is used in the description of the preferred embodiments, the locations are not limited to houses. Any subscriber location is suitable for use with the present invention. Also shown in FIG. 1 is fiber optic cable 110 for carrying an optical cable signal containing the full optical cable spectrum of information. Junction box 111 for filtering the optical cable signal, converting the optical cable signal into a wideband wireless signal, and transmitting the wideband wireless signal, is shown connected to fiber optic cable 110. In any complete system, there can be more than one junction box 111. The junction boxes would be located at predetermined distances throughout the system to transceive information throughout the various neighborhoods.

Also shown in FIG. 1 are house nodes 121-124 for receiving the wideband wireless signal, filtering the received signal to pass only signals for the particular house, and converting the filtered signal into a signal compatible with transmission throughout the house. The filtering allows the company to control the signals received by a particular subscriber. By way of example, and in order to maintain shorter transmission distances, house nodes 121 and 123 are also capable of relaying the wireless signal to another location, a function that will be described in greater detail below. The opposite transmission path from house to in ground fiber optic cable is also supported, that is, the house nodes 121-124 contain components for converting the in house signals to a format suitable for transmission, and junction box 111 contains components for converting the wideband wireless signal into a fiber optic cable signal, for purposes such as pay-per-view and Internet services, for example.

Although the converting of the signal is set forth above, the conversion step is required only in systems where the signal carrying mediums (i.e. signal carrier wavelengths) are different. For example, if a common optical signal is used in both the fiber optic and wideband wireless sections, no conversion of the signal would be required, further saving in costs to the consumer.

The wireless signal can be in the millimeter wave band (e.g., 100 GHz) or optical band. Both the millimeter wave band and the optical band are wideband spectrums that can carry transmit information in the giga bits per second (bps) range. When used herein, the term wideband will incorporate both the millimeter wave band and optical band unless otherwise stated, though a system would typically only use one of the bands.

Both the millimeter band and optical band signals comply with human exposure standards because the relative short distances require low power, the human body penetration of millimeter or optical bands is insignificant compared with microwave sources, and neither band is harmful to the human eye. As the wavelengths of both the millimeter wave bands and the optical bands are shorter than the wavelengths of microwaves, the millimeter wave bands and optical bands will not penetrate the human body as deeply as the microwave energies, even at the same power levels. Use of either the millimeter wave band or the optical band signal is within the scope of the present invention.

The general operation of the system will now be described with respect to FIG. 1. An optical cable signal on fiber optic cable 110 is received at junction box 111. Junction box 111 filters the optical cable signal to allow only channels for houses connected to this part of the system (e.g., houses 101-104) to pass. Next junction box 111 converts the filtered signal into a wideband wireless signal (i.e. millimeter wave band signal or optical band signal), depending on the configuration of the system. Finally, junction box 111 transmits the converted wideband wireless signal to house nodes 121 and 122 on houses 101 and 102, respectively.

Upon receipt of the wideband wireless signal, house nodes 121 and 122 filter the wideband wireless signal to pass information for that particular house, and house node 121 relays the entire wideband wireless signal to house node 123 on house 103. House node 121 then converts the wideband wireless signal into a signal compatible with transmission throughout house 101. House node 123 also filters and converts the signal for use in house 103, and also relays the entire wideband wireless signal to house node 124 on house 104.

As each house node 121-124 and junction box 111 are bi-directional devices, the reverse transmission path is also supported. In house signals from house 104 are converted by house node 124 into wideband wireless signals and transmitted to house node 123 of house 103. House node 123 receives the wideband wireless signal from house 104. House node 123 converts the in house signals from house 123 into wideband wireless signals and combines this signal with the wideband wireless signal received from house 104. The combining can be achieved using well-known multiplexing techniques. The combined signal is transmitted from house node 123 to house node 121, where a process similar to that occurring at house node 123 occurs. House node 121 combines signals from house 101 with the wideband wireless signal from house node 123, and then transmits the combined wideband wireless signal to junction box 111. Junction box 111 also receives a wideband wireless signal from house node 122 on house 102. The signal from house node 122 contains only information from house 102, as there is no relay of signals to and from house node 122 in this example.

Relays can be included or removed from house nodes depending on neighborhood configurations. Junction box 111 receives the wideband wireless signals from house node 121 and house node 122. The received wideband wireless signals are combined at junction box 111, and converted, if necessary, to fiber optic cable signals. The conversion step at the junction box 111 would not be necessary for wireless optical band signals that can be directly patched into the fiber optic cable.

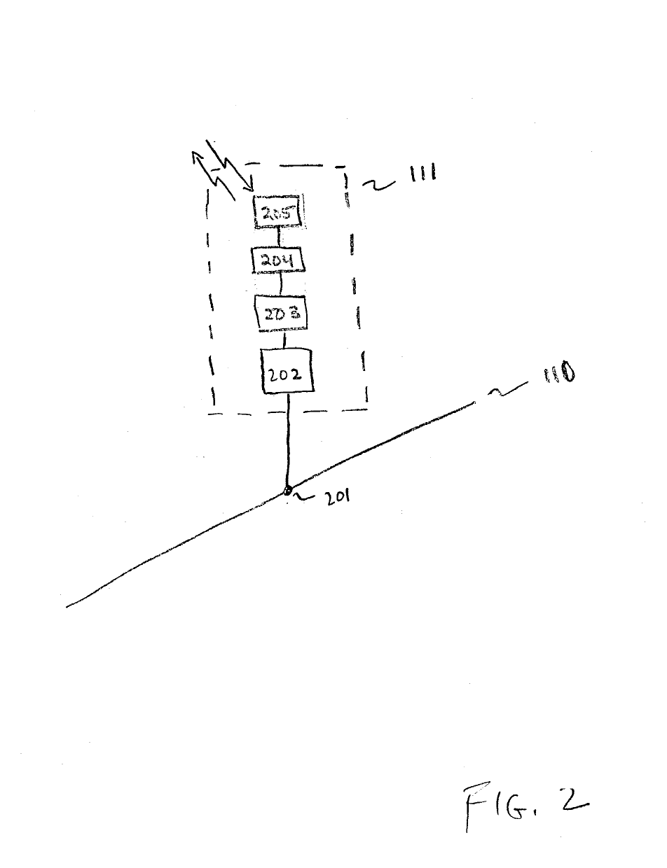

FIG. 2 is a diagram detailing a junction box shown in FIG. 1. Shown in FIG. 2 is fiber optic cable 110 for carrying the optical cable signal containing the full optical cable spectrum of information. Optical cable tap 201 for splitting the optical cable signal is shown connected to fiber optic cable 110. The split optical cable signal is transmitted to junction box 111. Contained in junction box 111 is filter 202, for filtering the optical cable signal, connected to converter 203, for converting the filtered optical cable signal into a wideband wireless signal, which is connected to transceiver 204, for transmitting and receiving the wideband wireless signal, which is in turn connected to dish antenna or optical lens 205 for transmission. Filter 202 and converter 203 can be interposed, although it would be more economical to have one filter for all systems rather that having a filter for a millimeter wave band or an optical band depending on the configuration of the system and converter. Also, as stated earlier, converter 203 would not be required if a wireless optical band signal used is compatible with the optical cable signal. Finally, dish antenna 205 is used in a millimeter wave band system, and optical lens 205 is used in a wireless optical band signal system.

The operation of junction box 111 will now be described with reference to FIG. 2. The optical cable signal of fiber optic cable 110 is split by fiber optic cable tap 201. The split optical cable signal is transmitted to filter 202 and also continues along fiber optic cable 110. Filter 202 filters the optical cable signal to allow only signals destined for down line houses to pass. The filtered optical cable signal is forwarded to converter 203. Converter 203 converts the filtered optical cable signal into a signal suitable for wideband wireless transmission. The conversion would be into a millimeter wave signal or a wireless optical band signal that is not compatible with fiber optic cable transmission. If a particular system were using a wireless optical band signal compatible with fiber optic cable transmission, converter 203 would not be required. Whether converter 203 is used or not, the signal is then received by transceiver 204. Transceiver 204 transmits and receives the wideband wireless signal through dish antenna 205 in a millimeter wave band system, or optical lens 205 in a wireless optical band system, to a house node.

As the junction box 111 of FIG. 2 is capable of bi-directional communications, the reverse process is also supported. First, dish antenna or optical lens 205 receives a wideband wireless signal from a house node. The received signal is converted by converter 203, if required. Filter 202 would then pass the entire received signal to fiber optical cable 110 through tap 201 for transmission throughout the fiber optic cable system. As is well known by those skilled in the art, a low noise receive amplifier (not shown) may be located in either or both of the junction box or house nodes for both the millimeter and optical bands to assure signal strength and quality (e.g., maintaining high signal to noise ratios) in accordance with the particular industry standards.

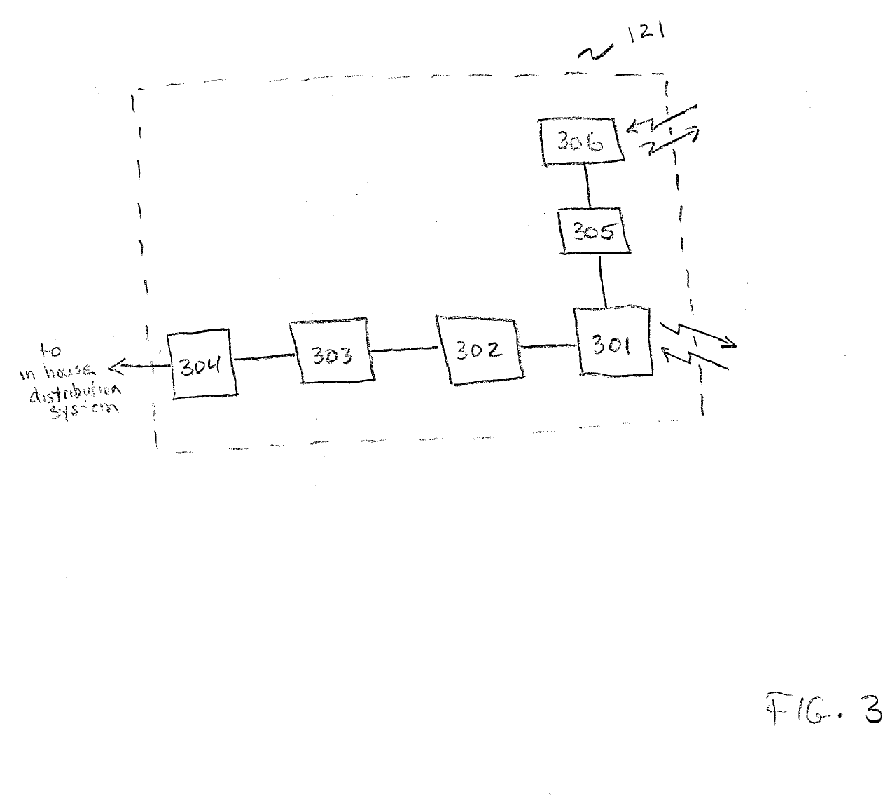

FIG. 3 is a diagram detailing a house node 121 of FIG. 1. Shown in FIG. 3 are dish antenna or optical lens 301 (depending on the wideband wireless signal system utilized) for transmitting and receiving wideband wireless signals. Dish antenna or optical lens 301 is connected to transceiver 302 and relay transceiver 305. Transceiver 302 is for transmitting and receiving the wideband wireless signal to and from house 101 (not shown). Filter 303 receives the wideband wireless signal from transceiver 302 and filters the received signal to allow only information for house 101 to pass. Converter 304 is connected to filter 303. Converter 304 converts the filtered signal from filter 303 into a format compatible with the in house network. Traditionally, the in house network is a coaxial wire based system, though the proper converter can support any in house distribution system. For example, fiber optic, Bluetooth®, radio frequency, etc., could be used, and if compatible with the wideband wireless optical signal, the converter would not be required.

As stated before, the wideband wireless signal received by dish antenna or optical lens 301 is also forwarded to relay transceiver 305. Relay transceiver 305 transmits and receives signals, through dish antenna or optical lens 306, from and to nearby house nodes as described with respect to FIG. 1. If there were not another house to relay the signal to, for example house 102 of FIG. 1, relay transceiver 305 and dish antenna or optical lens 306 would not be required. Also, as stated earlier in the description of junction box 111, converter 304 and filter 303 can be interposed, by making appropriate hardware changes. Also, encryption techniques (e.g., virtual private networking) can be utilized to protect against improper use of a signal.

Another advantage to the use of the millimeter or optical bands is that even severe weather could be overcome at such short distances by controlling the transmission power during the severe weather. The millimeter wave bands and optical bands are susceptible to absorption and scattering by water molecules, e.g., fog or rain. An added power amplifier could be incorporated into the junction box and/or house nodes to adjust the transmission power level. A power control signal is contemplated that could be sent from and received at the house nodes and junction boxes for use by the power amplifier to adjust the transmission power of the wide band wireless signal, whether millimeter wave band or optical band signals. Even severe weather could be overcome at such short distances by controlling the transmission power. The relaying feature from house node to house node facilitates this by shortening the respective distances the signal must travel. The transmission power level can be controlled to compensate for attenuation due to atmospheric conditions, for example, during fog or rain the power level can be increased, and during good conditions, the transmission power level can be reduced. By compensating for adverse weather conditions in this manner, a very high quality of service can be maintained.

Additionally, the house node/relay node unit can be located at a place other than a subscriber location. For example, the house node/relay node could be positioned on a utility pole between a junction box and a subscriber location to shorten the distance there between.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A system for bi-directional distribution of information between a fiber optic cable and at least one subscriber location having a distribution network for distributing the information within the subscriber location, comprising:
a junction box connected to a fiber optic cable for transceiving a signal transmitted over the fiber optic cable and a wideband wireless signal; and
a first house node located at a first of the at least one subscriber location for transceiving the wideband wireless signal and a signal for use in the distribution network of the at least one subscriber location.

2. The system of claim 1, further comprising:
a relay node connected to the house node for relaying the wideband wireless signal; and
a second house node located at a subscriber location different from the first of the at least one subscriber location for transceiving the wideband wireless signal to and from the relay node.

3. The system of claim 2, wherein the relay node comprises:
a transceiver for transceiving the wideband wireless signal; and
at least one of a dish antenna and an optical lens for transceiving the wideband wireless signal to and from the second house node,
wherein the dish antenna transceives a signal in a wideband millimeter wave band and the optical lens transceives a signal in a wideband wireless optical band.

4. The system of claim 2, further comprising:
a plurality of house nodes located at a plurality of subscriber locations; and
a plurality of relay nodes located at the plurality of subscriber locations,
wherein the plurality of house nodes and plurality of relay nodes transceive the wideband wireless signal between the plurality of subscriber locations.

5. The system of claim 1, wherein the junction box comprises:
a filter for filtering the signal from the fiber optic cable;
a converter for converting the filtered signal into a wideband wireless signal, and converting the wideband wireless signal into the fiber optic cable signal; and
at least one of a dish antenna and optical lens for transceiving the wideband wireless signal,
wherein the dish antenna transceives a signal in a wideband millimeter wave band and the optical lens transceives a signal in a wideband wireless optical band.

6. The system of claim 1, wherein the house node comprises:
at least one of a dish antenna or optical lens for transceiving the wideband wireless signal;
a transceiver for transceiving the wideband wireless signal;
a filter for filtering the received signal; and
a converter for converting the filtered signal into a signal compatible with the distribution network within the subscriber location, and converting the signal compatible with the distribution system within the subscriber location into the wideband wireless signal,
wherein the dish antenna transceives a signal in a wideband millimeter wave band and the optical lens transceives a signal in a wideband wireless optical band.

7. The system of claim 2, wherein the relay node connected to the house node is located at a location other that a subscriber location for shortening the distance the wideband wireless signal must be transmitted between the junction box and the subscriber location.

8. The system of claim 1, further comprising:
a power control signal generator for generating a power control signal; and
a power controller for controlling the transmission power level of the transceived signals of the junction box and house node according to the power control signal, said transmission power level being controlled to compensate for attenuation due to atmospheric conditions.

9. A method for bi-directional distribution of information between a fiber optic cable and at least one subscriber location having a distribution network for distributing the information within the subscriber location, comprising the steps of:
transceiving a signal of a fiber optic cable and a wideband wireless signal; and
transceiving the wideband wireless signal and a signal for use in the distribution network of the at least one subscriber location.

10. The method of claim 9, further comprising the steps of:
relaying the wideband wireless signal; and
transceiving at a subscriber location different from the first of the at least one subscriber location the wideband wireless signal.

11. The method of claim 10, wherein the relaying step further comprises the steps of:
transceiving the wideband wireless signal; and
transceiving by at least one of a dish antenna and an optical lens the wideband wireless signal to and from the second house node,
wherein the dish antenna transceives a signal in a wideband millimeter wave band and the optical lens transceives a signal in a wideband wireless optical band.

12. The method of claim 10, further comprising the step of transceiving by a plurality of house nodes located at a plurality of locations and a plurality of relay nodes located at the plurality of locations the wideband wireless signal between the plurality of locations.

13. The method of claim 9, wherein the transceiving by the junction box further comprises the steps of:
filtering the signal from the fiber optic cable;
converting the filtered signal into a wideband wireless signal, and converting the wideband wireless signal into the fiber optic cable signal; and
transceiving by at least one of a dish antenna and optical lens the wideband wireless signal,
wherein the dish antenna transceives a signal in a wideband millimeter wave band and the optical lens transceives a signal in a wideband wireless optical band.

14. The method of claim 9, wherein the transceiving by the house node further comprises the steps of:
transceiving by at least one of a dish antenna or optical lens the wideband wireless signal;
transceiving the wideband wireless signal;
filtering the received signal; and
converting the filtered signal into a signal compatible with the distribution network within the subscriber location, and converting the signal compatible with the distribution network within the subscriber location into the wireless wideband signal,
wherein the dish antenna transceives a signal in a wideband millimeter wave band and the optical lens transceives a signal in a wideband wireless optical band.

15. The method of claim 9, further comprising the steps of:
generating a power control signal; and
controlling the transmission power level of transceived signals according to the power control signal, said transmission power level being controlled to compensate for attenuation due to atmospheric conditions.

16. A system for the bi-directional distribution of information between a fiber optic cable and at least one subscriber location having a distribution network for distributing the information within the subscriber location, comprising:
means for transceiving a signal of a fiber optic cable as a wideband wireless signal; and
means for transceiving the wideband wireless signal as a signal for use in the distribution system of the at least one subscriber location.

17. The system of claim 16, further comprising:
means for relaying the wideband wireless signal to a second subscriber location; and
means for transceiving the wideband wireless signal to and from the second subscriber location to the relaying means.

18. The system of claim 16, further comprising:
means for generating a power control signal; and
means for controlling the transmission power level of the transceiving means according to the power control signal, said transmission power level being controlled to compensate for attenuation due to atmospheric conditions.
